(19) United States
(12) Patent Application Publication
(10) Pub. No.: US 2025/0154299 A1
(43) Pub. Date: May 15, 2025

(54) CATALYST COMPONENT

(71) Applicant: INEOS EUROPE AG, Rolle (CH)

(72) Inventors: Atanas TOMOV, Croydon (GB); Michel CLAREMBEAU, Temploux (BE); Andreas ERNST, Missouri City, TX (US)

(21) Appl. No.: 18/836,797

(22) PCT Filed: Feb. 7, 2023
(86) PCT No.: PCT/EP2023/052944

§ 371 Date: Aug. 8, 2024

(30) Foreign Application Priority Data
Feb. 9, 2022 (EP) 22155898.4

(51) Int. Cl. C08F 10/06

(52) U.S. Cl. CPC C08F 10/06

(57) ABSTRACT

Components useful in propylene polymerization catalysts, and in particular a solid, hydrocarbon-insoluble, catalyst component containing magnesium, titanium, and halogen and further comprising a modifier compound with a structure (1):

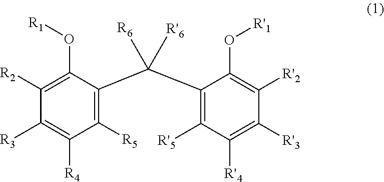

wherein

R1 and R′1 are each independently selected from alkylaryl, aryl or alkyl groups having 1 to 10 carbon atoms, R2 to R5 and R′2 to R′5 are each independently selected from H and alkyl groups having 1 to 6 carbon atoms, R6 and R′6 are each independently selected from H and alkyl groups having 1 to 4 carbon atoms, and the alkyl groups optionally comprising one or more heteroatoms.

### FIELD AND BACKGROUND OF THE INVENTION

This invention relates to components useful in catalysts, and particularly relates to modifier components used in combination with magnesium-containing supported titanium-containing catalyst components.

Use of solid, transition metal-based, olefin polymerization catalyst components is well known in the art, including such solid components supported on a metal oxide, halide or other salt such as widely-described magnesium-containing, titanium halide-based catalyst components. Although many polymerization and copolymerization processes and catalyst systems have been described for polymerizing or copolymerizing alpha-olefins, it is advantageous to tailor a process and catalyst system to obtain a specific set of properties of a resulting polymer or copolymer product. For example, in certain applications, a combination of high activity, good morphology, desired particle size distribution, acceptable bulk density, and the like are required together with polymer characteristics such as stereospecificity, molecular weight distribution, and the like.

Typically, supported catalyst components useful for polymerizing propylene and higher alpha-olefins as well as for polymerizing propylene and higher olefins with minor amounts of ethylene and other alpha-olefins contain an electron donor component as an internal modifier. Such an internal modifier is an integral part of the solid supported component and is distinguished from any external electron donor component, which together with an aluminium alkyl component, may comprise the catalyst system. Typically, co-catalyst, such as aluminium alkyl, and any external electron donor are combined with the solid catalyst component, either shortly before the combination is contacted with an olefin monomer or in the presence of olefin monomer.

Selection of the internal modifier and other electron donor components can affect catalyst performance and the resulting polymer formed. A large number of organic electron donors have been described as useful in preparation of the stereospecific supported catalyst components including organic compounds containing oxygen, nitrogen, sulphur, and/or phosphorus. Such compounds include organic acids, organic acid anhydrides, organic acid esters, alcohols, ethers, aldehydes, ketones, amines, amine oxides, amides, thiols, various phosphorus acid esters and amides, and the like. Mixtures of organic electron donors have been described as useful in incorporating into supported catalyst components. Specific examples of organic electron donors typically used as internal modifiers include dicarboxylate esters, such as alkyl phthalates, succinate esters and other bidentate donors, such as diethers.

It is also known that, in addition to a co-catalyst, the external donor components of the catalyst can include several components. WO 2005/30815 and WO 2009/85649, for example, describe propylene polymerization catalysts which, in addition to one or more aluminium containing co-catalysts; include a combination of external donors, and in particular at least one alkoxysilane, which is referred to as a “selectivity control agent” (SCA) and at least one aliphatic or cycloaliphatic mono- or poly-carboxylic acids; or ester derivative thereof, which is referred to as an “activity limiting agent” (ALA).

Further, numerous individual processes or process steps have been disclosed to produce improved supported, magnesium-containing, titanium-containing, electron donor-containing olefin polymerization or copolymerization catalysts. For example, U.S. Pat. No. 4,866,022 discloses a method for forming an advantageous alpha-olefin polymerization or copolymerization catalyst or catalyst component which involves a specific sequence of individual process steps. U.S. Pat. No. 4,540,679, discloses a process for the preparation of a magnesium hydrocarbyl carbonate by reacting a suspension of a magnesium alcoholate in an alcohol with carbon dioxide and reacting the magnesium hydrocarbyl carbonate with a transition metal component. U.S. Pat. No. 4,612,299, discloses a process for the preparation of a magnesium carboxylate by reacting a solution of a hydrocarbyl magnesium compound with carbon dioxide to precipitate a magnesium carboxylate and reacting the magnesium carboxylate with a transition metal component.

Particular uses of propylene polymers depend upon the physical properties of the polymer, such as molecular weight, viscosity, stiffness, flexural modulus, and polydispersity index (molecular weight distribution (Mw/Mn)). In addition, polymer or copolymer morphology typically depends upon catalyst morphology.

### SUMMARY OF THE INVENTION

The present invention relates to catalyst components and catalysts and in particular comprising a new modifier component.

Thus, in a first aspect the present invention provides a solid, hydrocarbon-insoluble, catalyst component containing magnesium, titanium, and halogen and further comprising a modifier compound with a structure (1):

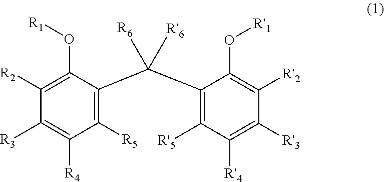

wherein
R₁ and R′₁ are each independently selected from alkylaryl, aryl or alkyl groups having 1 to 10 carbon atoms,
R₂ to R₅ and R′₂ to R′₅ are each independently selected from H and alkyl groups having 1 to 6 carbon atoms,
R₆ and R′₅ are each independently selected from H and alkyl groups having 1 to 4 carbon atoms, and the alkyl groups optionally comprising one or more heteroatoms.

The catalyst component is particularly useful, in conjunction with a co-catalyst, as a catalyst for the polymerization of olefins.

Thus, in a second aspect, the present invention also provides a catalyst useful in polymerizing olefins, said catalyst comprising:

(i) a solid, hydrocarbon-insoluble, catalyst component containing magnesium, titanium, and halogen and further comprising a modifier compound with a structure (1):

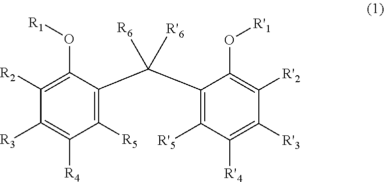

wherein
R₁ and R′₁ are each independently selected from alkylaryl, aryl or alkyl groups having 1 to 10 carbon atoms,
R₂ to R₅ and R′₂ to R′₅ are each independently selected from H and alkyl groups having 1 to 6 carbon atoms,
R₆ and R′₅ are each independently selected from H and alkyl groups having 1 to 4 carbon atoms, and the alkyl groups optionally comprising one or more heteroatoms; and

(ii) at least one co-catalyst component.

### DETAILED DESCRIPTION

For avoidance of doubt, the modifier is, and may also be considered as, an electron donor compound. The modifier as claimed may be used as an external electron donor in the first and second aspects of the present invention, but in preferred embodiments is used as an internal electron donor or, specifically, an “internal modifier”.

(As used herein the term “modifier” is used as short-hand to refer to the modifier compound of structure (1), and the terms “modifier” and “modifier compound” may be used interchangeably. The term “modifier” is used in the present invention to provide a clear distinction in terminology for the modifier of structure (1) from other electron donors which may be present in any aspect or embodiment.)

The terms “internal” and “external” as used in this context are well understood in the art. In general, and as used herein, the term “internal” when used in reference to a modifier (or other electron donor) refers to a compound which is an integral part of the solid supported catalyst component. Generally, this is achieved by adding the internal modifier (or other electron donor) during the catalyst preparation. In contrast, the term “external” when used in reference to a modifier (or other electron donor) refers to a compound which is combined with the other parts of solid catalyst component either shortly before the combination is contacted with an olefin monomer or is combined with the other parts of the solid catalyst component in the presence of olefin monomer e.g. in a reactor.

In the present invention R₁ and R′₁ are each independently selected from alkylaryl, aryl or alkyl groups having 1 to 10 carbon atoms, R₂ to R₅ and R′₂ to R′₅ are each independently selected from H and alkyl groups having 1 to 6 carbon atoms, and R₆ and R′₆ are each independently selected from H and alkyl groups having 1 to 4 carbon atoms.

The alkyl groups may optionally comprise one or more heteroatoms. This is discussed further below.

In preferred embodiments, R₁ and R′₁ are each the same alkylaryl, aryl or alkyl group. As used herein the term alkylaryl (group) refers to a group which comprises an alkyl connected to an aryl group. Preferred examples include alkylbenzene groups, such as benzyl (—CH2C6H5—), and including derivatives thereof which are substituted on the benzene ring.

In one embodiment, R₁ and R′₁ may be aryl. Preferred examples include phenyl (—C6H5), benzoyl (—C(═O) C6H5), and derivatives thereof which are substituted on the phenyl ring. Most preferred examples are where R₁ and R′₁ are both C(═O) C6H5 or are both-C(═O) C6H4F, particularly on the latter where the fluoride is in the ortho position.

When R₁ and R′₁ are alkyl, then it is preferred that the alkyl group or groups (if R₁ and R′₁ are different) have 1 to 4 carbon atoms. In embodiments R₁ and R′₁ are each methyl, ethyl or benzyl groups. R₁ and R′₁ both being methyl is preferred.

In preferred embodiments R₂ to R₅ and R′₂ to R′₅ are each independently selected from H and alkyl groups having 1 to 4 carbon atoms.

Preferred alkyl groups include methyl, ethyl and tert-butyl groups.

In preferred embodiments Rₙ and the corresponding R′ₙ, where n is the same (e.g. R₂ and R′₂, R₃ and R′₃ etc.) are the same alkyl group.

For example, R₂ and R′₂ may both be H, may both be methyl, may both be ethyl or may both be isobutyl.

It is preferred that at least one of R₂ to R₅ and at least one of R′₂ to R′₅ is an alkyl, and at least one of R₂ to R₅ and at least one of R′₂ to R′₅ is H. In most preferred embodiments two of R₂ to R₅ and two of R′₂ to R′₅ are alkyl, and two of R₂ to R₅ and two of R′₂ to R′₅ are H.

In preferred embodiments, R₆ and R′₆ are each independently selected from H, methyl and ethyl groups. Preferably at least one of R₆ and R′₆ is H, and most preferably both are H. A particularly preferred combination, especially with R₁ and R′₁ both being methyl and

R₆ and R′₆ both being H comprises

R₂ and R′₂ are both methyl, both ethyl or both tert-butyl, preferably both tert-butyl.

R₃ and R′₃ are both H.

R₄ and R′₄ are both methyl, both ethyl or both tert-butyl, preferably both methyl.

R₅ and R′₅ are both H.

More generally in the present invention, and although not preferred, any of the alkyl groups may be substituted with heteroatoms. Examples include oxygen, sulphur, nitrogen, phosphorus, silicon or halogens. For example, an alkyl group used in this invention may be substituted with a nitrogen in the form of an amine group, with nitrogen and oxygen in the form of an amide group, or with chloro, bromo or silyl groups. Cyclic alkyl or aryl structures may contain hetero atoms such as oxygen, sulphur, nitrogen, silicon, and phosphorus.

Preferred heteroatoms, if present, are oxygen, nitrogen and halogens. In one embodiment R₁ and R′₁ may each comprise oxygen, and in particular the oxygen atoms of structure (1) (i.e. the oxygens in O—R₁ and O—R′₁) may each connect to a carbonyl in R₁ and R′₁ to form ester linkages. Examples include R₁ and R′₁ being-C(═O) C6H5, and derivatives thereof which are substituted on the phenyl ring as already described. In other embodiments, however, neither R₁ or R′₁ comprise heteroatoms i.e. they comprise solely C and H atoms.

It is preferred that neither R₆ or R′₆ comprise heteroatoms i.e. they comprise solely C and H atoms.

In embodiments, heteroatoms may be present in one or more of the alkyl groups of R₂ to R₅ and R′₂ to R′₅. Where this the case any heteroatom in these groups is preferably oxygen. More preferably at most one of R₂ to R₅ and one of R′₂ to R′₅ comprise heteroatoms. For example, one of R₂ to R₅ and also the equivalently numbered group from R′₂ to R′₅ may comprise oxygen, such as an alkoxy group. More preferably still, none of R₂ to R₅ and R′₂ to R′₅ comprise heteroatoms.

Most preferably, none of R₁ to R₆ or R′₁ to R′₅ comprise heteroatoms i.e. they comprise solely C and H atoms.

In preferred embodiments the modifier, particularly one of the preferred modifiers described above, is present in the catalyst component as an internal modifier.

It should also be noted that mixtures of modifier compounds described by the structure (1) may be used as well as mixtures of such compounds with other donor compounds known in the art. Examples of this are described further below.

The solid, hydrocarbon-insoluble, catalyst component generally comprises titanium compounds supported on magnesium-containing compounds, in combination with the modifier compound. The halogen present may be present as a component of the titanium and/or magnesium compounds. The halogen is preferably a chloride. In preferred embodiments, where the modifier is an internal modifier, then the supported titanium-containing olefin polymerization catalyst component typically is formed by reacting a titanium compound, a modifier compound and a magnesium-containing compound. Optionally, such supported titanium-containing reaction product may be further treated or modified by further chemical treatment.

Suitable magnesium-containing compounds include magnesium halides; a reaction product of a magnesium halide such as magnesium chloride or magnesium bromide with an organic compound, such as an alcohol or an organic acid ester, or with an organometallic compound of metals of Groups I-III; magnesium alcoholates; or magnesium alkyls.

Suitable titanium-containing compounds include titanium (IV) compounds, such as titanium (IV) halides. A particularly preferred titanium compound for use in such steps is TiCl₄, although numerous other species, such as other titanium (IV) halides or titanium alcoholates are also known to be suitable.

The present invention is not limited to a catalyst component prepared by any specific method of preparation.

For example, the catalyst component comprising an internal modifier may be prepared by reacting the magnesium and titanium compounds and the modifier compound in any suitable order. For example, the catalyst components may be prepared by reacting the magnesium and titanium compounds first, and then incorporation of the modifier compound. Alternatively, the modifier may be incorporated prior to the titanium compound, during the addition of the titanium compound, or (in multiple steps) in a combination thereof.

Generally, the aforesaid modifier compounds and titanium compounds may be contacted with solid particles of a magnesium compound in the presence of an inert hydrocarbon or halogenated diluent, although other suitable techniques can be employed. Suitable diluents are substantially inert to the components employed and are liquid at the temperature and pressure employed.

Most typically, a solution or solutions of titanium tetrachloride and the modifier compound is/are contacted with a magnesium-containing material, for example by addition to a slurry of magnesium containing particles in a suitable hydrocarbon. Such magnesium-containing material typically is in the form of discrete particles and may contain other materials such as transition metals and organic compounds. Also, a mixture of magnesium chloride, titanium tetrachloride and the modifier may be formed into an active catalyst component by ball-milling.

In a preferred method, however, a slurry of a magnesium containing material is first contacted with a solution of the modifier, typically with stirring. The obtained solution is then be treated with a suitable titanium containing species. Several steps may be applied for addition of the internal donor or the titanium, or both.

In one particularly advantageous procedure, magnesium chloride-based support particles suspended in a liquid hydrocarbon diluent, such as toluene, are first contacted with titanium tetrachloride, and then with a modifier compound, these two contacting steps being repeated one or more times, before a final contacting step with titanium tetrachloride (i.e. without the subsequent addition step of further modifier). The diluent used may be decanted between steps and fresh diluent added prior to the next step. After the final step the diluent is removed, and the product is washed one or more times with a liquid hydrocarbon, such as heptane, and then dried.

The conditions in such steps are known in the art. The steps are usually performed at elevated temperatures, typically from 75 to 135° C., and at normal or slightly elevated pressures from 1 to 3 bar. Typical individual treatment times for each step may vary from several minutes to several hours, usually from 0.25 to 3 hours.

As a result of the preparation steps, there is obtained a solid reaction product suitable for use as a catalyst or catalyst component. Prior to such use, it is desirable to remove incompletely-reacted starting materials from the solid reaction product. This is conveniently accomplished by washing the solid, after separation from any preparative diluent, with a suitable solvent, such as a liquid hydrocarbon or chlorocarbon, preferably within a short time after completion of the preparative reaction because prolonged contact between the catalyst component and unreacted starting materials may adversely affect catalyst component performance.

Although not required, the final solid reaction product may be washed with an inert liquid hydrocarbon or halogenated hydrocarbon before contact with a Lewis acid. If such a wash is conducted, it is preferred to substantially remove the inert liquid prior to contacting the washed solid with Lewis acid.

In a typical catalyst component in the present invention, the magnesium to titanium molar ratio is at least 1:1, and preferably up to 20:1. Greater amounts of magnesium may be employed without adversely affecting catalyst component performance, but typically there is no need to exceed a magnesium to titanium ratio of 20:1. More preferably, the magnesium to titanium ratio ranges from 2:1 to 20:1, such as from 5:1 to 20:1.

The catalyst component of the present invention generally comprises from 1 to 6 weight percent titanium, from 10 to 25 weight percent magnesium, and from 45 to 65 weight percent halogen. Preferably, the catalyst component comprises from 2 to 4 weight percent titanium, from 15 to 21 weight percent magnesium and from 55 to 65 weight percent chlorine.

The modifier component, when used as an internal modifier, is typically incorporated into the solid catalyst component in a molar ratio of modifier to titanium at least 0.1:1 and/or up to 10:1. The molar ratio is preferably at least 0.2:1, and more preferably at least 0.4:1. The molar ratio is preferably up to 5:1, such as up to 2:1. A molar ratio of modifier to titanium in the range of 0.4:1 to 1.2:1 is most preferred.

As already noted, in an embodiment of the present invention, mixtures of electron donors may be used. This includes mixtures of two or more modifier compounds described by the structure (1) as well as mixtures of compounds of the structure (1) with other electron donor compounds known in the art.

For example, where the modifier of structure (1) is used as an internal modifier (internal electron donor), then the modifier may be used as a component of an internal donor mixture. Preferably, in these embodiments the internal donor mixture is a mixture of at least one compound of the structure (1) with at least one other electron donor compound known in the art (hereinafter referred to as an “additional internal donor”).

In one embodiment the additional internal donor may be a dialkylphthalate. For example, the additional internal donor may be a dialkylphthalate wherein each alkyl group may be the same or different and contains from 3 to 5 carbon atoms, preferably a dibutylphthalate and more preferably is di-n-butylphthalate or di-i-butylphthalate. Alternatively, the additional internal donor may be a dialkylphthalate wherein each alkyl group may be the same or different and each contains at least 6 carbon atoms, preferably up to 10 atoms. Particular dialkylphthalates which are suitable include dihexylphthalate and dioctylphthalate.

In an alternative, the additional internal donor may be a dicycloaliphatic ester of an aromatic dicarboxylic acid wherein each cycloaliphatic moiety may be the same or different and each contains from 5 to 7 carbon atoms, and preferably contains 6 carbon atoms. Preferably the ester is a dicycloaliphatic diester of an ortho aromatic dicarboxylic acid. Particular dicycloaliphatic esters that are suitable include dicyclopentylphthalate, dicyclohexylphthalate, and di-(methylcyclopentyl)-phthalate.

In another option, the additional internal donor may be an alkyl-arylalkyl phthalate wherein the alkyl moiety contains 2 to 10, preferably 3 to 6, carbon atoms, and the arylalkyl moiety contains from 7 carbon atoms up to 10, preferably up to 8, carbon atoms. Particularly, alkyl-arylalkyl phthalates suitable include benzyl n-butyl phthalate and benzyl i-butyl phthalate.

Also, the additional internal donor may be an alkyl ester of an aliphatic monocarboxylic acid wherein carboxylic acid moiety contains 2 to 20, preferably 3 to 6, carbon atoms and the alkyl moiety contains from 1 to 3 carbon atoms. Preferably the additional internal donor is an alkyl ester of an aliphatic monocarboxylic acid. Particular alkyl esters that are suitable include methyl valerate, ethyl pivalate, methyl pivalate, methyl butyrate, and ethyl propionate.

In another alternative, such additional internal donor also may be an alkyl ester of an aromatic monocarboxylic acid wherein the monocarboxylic acid moiety contains from 6 to 8 carbon atoms and the alkyl moiety contains from 1 to 3 carbon atoms. Particular alkyl esters that are suitable in this case include methyl toluate, ethyl toluate, methyl benzoate, ethyl benzoate and propyl benzoate.

In a yet further alternative, the additional internal donor also may be a 1,3-diether, and particularly a 2,2-di-substituted-1,3-diether. Preferred examples include 2-isopropyl-2-isobutyl-1,3-dimethoxypropane, 2,2-diisobutyl-1,3-dimethoxypropane, 2-isopropyl-2-isopentyl-1,3-dimethoxypropane, 2,2-dicyclohexyl-1,3-dimethoxypropane, 2,2-bis(cyclohexylmethyl)-1,3-dimethoxypropane, and 9,9-bis(methoxymethyl) fluorene. Among these, 2-isopropyl-2-isobutyl-1,3-dimethoxypropane, 2-isopropyl-2-isopentyl-1,3-dimethoxypropane, and 9,9-bis(methoxymethyl) fluorene are preferable.

The mole ratio of the additional internal donor to the (internal) modifier in all options above may, for example, range from 5:95 to 95:5.

The catalyst or catalyst component of this invention may be used in the polymerization or copolymerization of alpha olefins. Pre-polymerization or encapsulation of the catalyst or catalyst component may be carried out prior to being used in the polymerization. A particularly useful pre-polymerization procedure is described in U.S. Pat. No. 4,579,836.

Typically, the catalyst component of the present invention is used for polymerization in conjunction with a cocatalyst component. The cocatalyst component may be a Group II or III metal alkyl. Useful Group II and IIIA metal alkyls are compounds of the formula MRm wherein M is a Group II or Ill metal, each R is independently an alkyl radical of 1 to 20 carbon atoms, and m corresponds to the valence of M. Examples of useful metals, M, include magnesium, calcium, zinc, cadmium, aluminium, and gallium. Examples of suitable alkyl radicals, R, include methyl, ethyl, butyl, hexyl, decyl, tetradecyl, and eicosyl. From the standpoint of catalyst or catalyst component performance, preferred Group II and IIIA metal alkyls are those of magnesium, zinc, and aluminium wherein the alkyl radicals contain 1 to 12 carbon atoms. Specific examples of such compounds include Mg(CH₃)₂, Mg(C₂H₅)₂, Mg(C₂H₅) (C₄H₉), Mg(C₄H₉)₂, Mg(C₆H₁₃)₂, Mg(C₁₂H₂₅)₂, Zn(CH₃)₂, Zn(C₂H₅)₂, Zn(C₄H₉)₂, Zn(C₄H₉) (C₈H₁₇), Zn(C₆H₁₃)₂, Zn(C₆H₁₃)₃, and Al(C₁₂H₂₅)₃. A magnesium, zinc, or aluminium alkyl containing 1 to 6 carbon atoms per alkyl radical may preferably be used.

Aluminium alkyls are most preferred as co-catalyst and even more preferably trialkylaluminiums containing 1 to 6 carbon atoms per alkyl radical. Particularly triethylaluminium and triisobutylaluminium or a combination thereof can be used.

If desired, however, metal alkyls having one or more halogen or hydride groups can be employed, such as ethylaluminium dichloride, diethylaluminium chloride, and the like.

The catalyst for the polymerization or copolymerization of alpha olefins may be formed by combining the supported titanium-containing catalyst component of the first aspect of the present invention and a co-catalyst component, preferably an alkyl aluminium compound.

Typically, useful aluminium-to-titanium molar ratios in such catalyst systems are 10:1 to 2000:1 and preferably 50:1 to 1500:1.

Typically, the catalyst component of the present invention is used for polymerization in conjunction with a co-catalyst and also with one or more further electron donor compounds. In particular, in one embodiment of the present invention modifiers of structure (1) may be used as both internal and external electron donors for the catalyst, either alone or in combination with other suitable electron donors.

In preferred embodiments, however, the modifier is used as an internal modifier (or internal electron donor), optionally as part of an internal donor mixture as described, and is further used in conjunction with one or more other external electron donors.

Typical aluminium-to-external electron donor molar ratios in such catalyst systems are 2 to 60.

A preferred external electron donor is a silane. Typical aluminium-to-silane compound molar ratios in such catalyst systems are 3 to 50. Preferable silanes include alkyl-, aryl-, and/or alkoxy-substituted silanes containing hydrocarbon moieties with 1 to 20 carbon atoms. Especially preferred are silanes having a formula: SiY₄, wherein each Y group is the same or different and is an alkyl or alkoxy group containing 1 to 20 carbon atoms. Preferred silanes include isobutyltrimethoxysilane, diisobutyldimethoxysilane, diisopropyldimethoxysilane, n-propyltriethoxysilane, isobutylmethyldimethoxysilane, isobutylisopropyldimethoxysilane, dicyclopentyldimethoxysilane, tetraethylorthosilicate, dicyclohexyldimethoxysilane, diphenyldimethoxysilane, di-t-butyldimethoxysilane, and t-butyltrimethoxysilane.

Other compounds useful as external electron donors, either as an alternative to or in addition to one or more silanes, are organic compounds containing oxygen, nitrogen, sulphur, and/or phosphorus. Such compounds include organic acids, organic acid anhydrides, organic acid esters, alcohols, ethers, aldehydes, ketones, amines, amine oxides, amides, thiols, various phosphorus acid esters and amides, and the like. Mixtures of external electron donors may be used.

Particular organic acids and esters are benzoic acid, halobenzoic acids, phthalic acid, isophthalic acid, terephthalic acid, and the alkyl esters thereof wherein the alkyl group contains 1 to 6 carbon atoms such as methyl chlorobenzoates, butyl benzoate, isobutyl)benzoate, methyl anisate, ethyl anisate, methyl p-toluate, hexylbenzoate, and cyclohexyl-benzoate, and diisobutyl phthalate as these give good results in terms of activity and stereospecificity and are convenient to use.

The catalyst or catalyst component of this invention is useful in the stereospecific polymerization or copolymerization of alpha-olefins containing 3 or more carbon atoms such as propylene, butene-1, pentene-1,4-methylpentene-1 and hexene-1, as well as mixtures thereof and mixtures thereof with ethylene.

Thus, in a third aspect, the present invention provides a process to polymerize propylene or a mixture of propylene and ethylene or a C4-C5 alpha-olefin, which process comprises using a catalyst according to the second aspect.

The catalyst or catalyst component of this invention is particularly effective in the stereospecific polymerization or copolymerization of propylene or mixtures thereof with up to 30 mole percent ethylene or a higher alpha-olefin. Highly crystalline polyalpha-olefin homopolymers or copolymers can be prepared by contacting at least one alpha-olefin with the catalyst or catalyst components under polymerization or copolymerization conditions. Such conditions include polymerization or copolymerization temperature and time, pressure(s) of the monomer(s), avoidance of contamination of catalyst, choice of polymerization or copolymerization medium in slurry processes, the use of additives to control homopolymer or copolymer molecular weights, and other conditions well known to persons skilled in the art. Slurry-, bulk-, and vapor-phase polymerization or copolymerization processes are contemplated herein.

The amount of the catalyst or catalyst component to be used varies depending on choice of polymerization or copolymerization technique, reactor size, monomer to be polymerized or copolymerized, and other factors known to persons of skill in the art, and can be determined on the basis of the examples appearing hereinafter. Typically, the catalyst or catalyst component of this invention is used in amounts ranging from 0.2 to 0.02 milligrams of catalyst to gram of polymer or copolymer produced.

Irrespective of the polymerization or copolymerization process employed, polymerization or copolymerization should be carried out at temperatures sufficiently high to ensure reasonable polymerization or copolymerization rates and avoid unduly long reactor residence times, but not so high as to result in the production of unreasonably high levels of stereo-random products due to excessively rapid polymerization or copolymerization rates. Generally, temperatures range from 0° to 120° C. with a range of from 20° C. to 95° C. being preferred from the standpoint of attaining good catalyst performance and high production rates. More preferably, polymerization is carried out at temperatures ranging from 50° C. to 80° C.

Olefin polymerization or copolymerization may be carried out at monomer pressures of atmospheric or above. Generally, monomer pressures range from 140 to 4100 kPa, although in vapor phase polymerizations or copolymerizations monomer pressures should not be below the vapor pressure at the polymerization or copolymerization temperature of the alpha-olefin to be polymerized or copolymerized.

The polymerization or copolymerization time will generally range from ½ to several hours in batch processes with corresponding average residence times in continuous processes. Polymerization or copolymerization times ranging from 1 to 4 hours are typical in autoclave-type reactions. In slurry processes, the polymerization or copolymerization time can be regulated as desired. Polymerization or copolymerization times ranging from ½ to several hours are generally sufficient in continuous slurry processes.

Diluents suitable for use in slurry polymerization or copolymerization processes include alkanes and cycloalkanes such as pentane, hexane, heptane, n-octane, isooctane, cyclohexane, and methylcyclohexane; alkylaromatics such as toluene, xylene, ethylbenzene, isopropylbenzene, ethyl toluene, n-propyl-benzene, diethylbenzenes, and mono- and dialkylnaphthalenes; halogenated and hydrogenated aromatics such as chlorobenzene. Chloronaphthalene, ortho-dichlorobenzene, tetrahydro-naphthalene, decahydronaphthalene; high molecular weight liquid paraffins or mixtures thereof, and other well-known diluents. It often is desirable to purify the polymerization or copolymerization medium prior to use, such as by distillation, percolation through molecular sieves, contacting with a compound such as an alkylaluminium compound capable of removing trace impurities, or by other suitable means.

Examples of gas-phase polymerization or copolymerization processes in which the catalyst or catalyst component of this invention may be used include both stirred bed reactors and fluidized bed reactor systems and are described in U.S. Pat. Nos. 3,957,448; 3,965,083; 3,971,786; 3,970,611; 4,129,701; 4,101,289; 3,652,527; and 4,003,712. Typical gas phase olefin polymerization or copolymerization reactor systems comprise at least one reactor vessel to which olefin monomer and catalyst components can be added and which contain an agitated bed of forming polymer particles. Typically, catalyst components are added together or separately through one or more valve-controlled ports in the single or first reactor vessel. Olefin monomer, typically, is provided to the reactor through a recycle gas system in which unreacted monomer removed as off-gas and fresh feed monomer are mixed and injected into the reactor vessel. For production of impact copolymers, homopolymer formed from the first monomer in the first reactor is reacted with the second monomer in the second reactor. A quench liquid, which can be liquid monomer, can be added to polymerizing or copolymerizing olefin through the recycle gas system in order to control temperature.

Irrespective of polymerization or copolymerization technique, polymerization or copolymerization is generally carried out under conditions that exclude water and other materials that act as catalyst poisons. Also, polymerization or copolymerization can be carried out in the presence of additives to control polymer or copolymer molecular weights. Hydrogen is typically employed for this purpose in a manner well known to persons of skill in the art. Although not usually required, upon completion of polymerization or copolymerization, or when it is desired to terminate polymerization or copolymerization or at least temporarily deactivate the catalyst or catalyst component of this invention, the catalyst can be contacted with water, alcohols, acetone, or other suitable catalyst deactivators in a manner known to persons of skill in the art.

The products produced are normally solid, predominantly isotactic polyalpha-olefins. Homopolymer or copolymer yields are sufficiently high relative to the amount of catalyst employed so that useful products can be obtained without separation of catalyst residues. Further, levels of stereo-random by-products are sufficiently low so that useful products can be obtained without separation thereof. The polymeric or copolymeric products produced in the presence of the catalyst or catalyst component can be fabricated into useful articles by extrusion, injection moulding, and other common techniques.

The polymer product primarily contains a high crystalline polymer of propylene. Polymers of propylene having substantial polypropylene crystallinity content now are well-known in the art. It has long been recognized that crystalline propylene polymers, described as “isotactic” polypropylene, contain crystalline domains interspersed with some non-crystalline domains. Non-crystalline domains can be due to defects in the regular isotactic polymer chain which prevent perfect polymer crystal formation. The extent of polypropylene stereoregularity in a polymer can be measured by well-known techniques such as isotactic index, crystalline melting temperature, flexural modulus, and, recently by determining the relative percent of meso pentads (% m4) by carbon-13 nuclear magnetic resonance (13C NMR).

The invention described herein is illustrated, but not limited, by the following examples.

### EXAMPLE

A supported catalyst component according to the present invention has been prepared and tested for propylene polymerisation as described below.

A 1 litre Buchi reactor was charged with magnesium ethoxide (20 g), toluene (125 mL) and then TiCl₄ (210 mL). The mixture was heated to 75° C. while stirring at 600 RPM. After holding for 1 hour at 75° C., the fluids were removed by filtration. Toluene (125 mL) and TiCl₄ (210 mL) were added, and the mixture was heated. When the temperature reached 75° C., Modifier-1 (5.3 g) was added. The reaction mixture was held at 105° C. for 2 hours, and the fluids were removed by filtration. TiCl₄ (210 mL) was added, the mixture was heated for 2.5 hours. The fluids were removed by filtration, TiCl₄ (210 mL) was added, and the mixture was heated for 0.5 hours. The fluids were removed by filtration, and the resulting solid catalyst was washed five times with heptane (200 ml portions), and dried under a stream of nitrogen in a drybox. Analytical results of the catalyst are shown in Table 1.

### Propylene Polymerizations.

Batch bulk propylene phase polymerization was performed in a 2 litre stainless steel autoclave at 71° C. while stirring at 450 revolutions per minute and with a reaction time of 1 hour. Triethylaluminium (TEAI) is used as a co-catalyst together with diisobutyldimethoxysilane as an external donor.

In particular, the dry, nitrogen-purged autoclave is charged with hydrogen (from a pressure drop of 1.7 MPa of a 100 mL vessel) and then with liquid propylene (900 mL). The mixture is bought to 39 C with stirring. Catalyst (8 mg), a heptane solution of TEAI (Al/Ti=1000) and a heptane solution of external donor (Al/Si=11) are quickly swept into the autoclave with a liquid propylene (400 mL) flush. The mixture is brought to polymerization temperature and held for 1 hour. The polymerization is terminated by venting the remaining propylene, and the polymer is dried in a vacuum oven.

The results are as shown in Table 1:

TABLE 1

| | | | | Modifier | | | | Powder |
|---|---|---|---|---|---|---|---|---|
| | | | | in | | MFR | | Bulk |
| | | Mg | Ti | catalyst | Yield | [g/10 | XS | Density |
| Ex. | Modifier | [wt %] | [wt %] | [wt %] | [kg/g] | min] | [wt %] | [g/cm] |
| 1 | 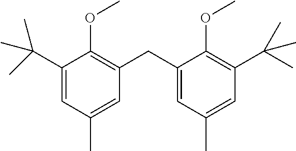 [SMILES: COc1c(Cc2cc(C)cc(C(C)(C)C)c2OC)cc(C)cc1C(C)(C)C] | 16.83 | 4.86 | n.d. | 26.9 | 75.9 | 16.82 | 0.355 |

The metals composition of the catalyst was determined by ICP-OES (Induction Coupled Plasma-Optical Emission Spectrometry). For the purposes of the present invention a sample of the catalyst was digested in a sealed bomb under microwave irradiation with a matrix of hydrochloric, nitric, and hydrofluoric acids. The resulting product was filtered and the content of the filtrate was analysed in an ICP spectrometer. “Yield” (kg of polymer produced per g of solid catalyst component) is based on the weight of solid catalyst used to produce polymer. The viscosity of the solid polymer was measured according to ASTM D1238 Condition L (2.16 kg@230° C.) and reported as the melt flow rate (MFR) in grams of polymer per 10 minutes. “Xylene Solubles” are determined by evaporating xylene from an aliquot of filtrate to recover the amount of soluble polymer produced and are reported as the weight percent (wt %) of such soluble polymer based on the sum of the weights of the solid polymer isolated by filtration and of the soluble polymer. The powder bulk density is reported in units of grams per cubic centimetre (g/cc). “n.d.” means no data/not determined.

The results show that the catalyst produced polypropylene in good yield.

1. A solid, hydrocarbon-insoluble, catalyst component containing magnesium, titanium, and halogen and further comprising a modifier compound with a structure (1): 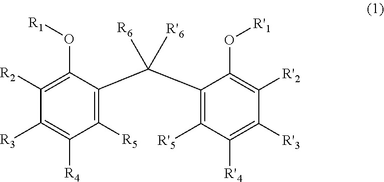
wherein
R₁ and R′₁ are each independently selected from alkylaryl, aryl or alkyl groups having 1 to 10 carbon atoms,
R₂ to R₅ and R′₂ to R′₅ are each independently selected from H and alkyl groups having 1 to 6 carbon atoms,
R₆ and R′₆ are each independently selected from H and alkyl groups having 1 to 4 carbon atoms, and
the alkyl groups optionally comprising one or more heteroatoms.

2. The catalyst component according to claim 1 wherein none of R₁ to Re or R′₁ to R′₅ comprise heteroatoms.

3. The catalyst component according to claim 1 wherein R₁ and R′₁ are each the same alkylaryl, aryl or alkyl group.

4. The catalyst component according to claim 1 wherein R₁ and R′₁ are each alkyl groups having 1 to 4 carbon atoms.

5. The catalyst component according to claim 1 wherein R₁ and R′₁ are both methyl.

6. The catalyst component according to claim 1 wherein R₂ to R₅ and R′₂ to R′₅ are each independently selected from H and alkyl groups having 1 to 4 carbon atoms.

7. The catalyst component according to claim 1 wherein at least one of R₂ to R₅ and at least one of R′₂ to R′₅ is an alkyl group, and at least one of R₂ to R₅ and at least one of R′₂ to R′₅ is H.

8. The catalyst component according to claim 1 wherein two of R₂ to R₅ and two of R′₂ to R′₅ are alkyl groups, and two of R₂ to R₅ and two of R′₂ to R′₅ are H.

9. The catalyst component according to claim 1 wherein R₂, R₄, R′₂ and R′₄ are alkyl groups, and R₃, R₅, R′₃ and R′₅ are H.

10. The catalyst component according to claim 1 wherein Rₙ and a corresponding R′ₙ, where n is the same, are the same alkyl group.

11. The catalyst component according to claim 1 wherein R₆ and R′₅ are each independently selected from H, methyl and ethyl groups.

12. The catalyst component according to claim 1 wherein Re and R′₆ are both H.

13. The catalyst component according to claim 1, wherein R₁ and R′₁ are both the same alkyl group of 1 to 4 carbon atoms, and R₆ and R′₆ are both H, wherein
R₂ and R′₂ are both methyl, both ethyl or both tert-butyl,
R₃ and R′₅ are both H,
R₄ and R′₄ are both methyl, both ethyl or both tert-butyl, and
R₅ and R′₅ are both H.

14. The catalyst component according to claim 1 wherein the modifier compound with the structure (1) is an internal modifier.

15. A catalyst useful in polymerizing olefins, said catalyst comprising
i) the solid, hydrocarbon-insoluble, catalyst component according to claim 1, and
ii) at least one co-catalyst component.

16. A process to polymerize propylene or a mixture of propylene and ethylene or a C4-C5 alpha-olefin, which process comprises using the catalyst according to claim 15.

17. A catalyst useful in polymerizing olefins, said catalyst comprising
i) the solid, hydrocarbon-insoluble, catalyst component according to claim 13, and
ii) at least one co-catalyst component.

18. A catalyst useful in polymerizing olefins, said catalyst comprising
i) the solid, hydrocarbon-insoluble, catalyst component according to claim 13, with R₁ and R′₁ both being methyl and R₆ and R′₆ both being H, and
ii) at least one co-catalyst component.

19. A process to polymerize propylene or a mixture of propylene and ethylene or a C4-C5 alpha-olefin, which process comprises using the catalyst according to claim 17.

20. A process to polymerize propylene or a mixture of propylene and ethylene or a C4-C5 alpha-olefin, which process comprises using the catalyst according to claim 18.
